(19) United States
(12) Patent Application Publication
(10) Pub. No.: US 2026/0002405 A1
(43) Pub. Date: Jan. 1, 2026

(54) SYSTEMS AND METHODS OF SECURING FENESTRATION SYSTEM FRAME MEMBERS

(71) Applicant: Arconic Technologies LLC, Pittsburgh, PA (US)

(72) Inventor: Mathieu FAUQUENOY, Vendargues (FR)

(73) Assignee: Arconic Technologies LLC, Pittsburgh, PA (US)

(21) Appl. No.: 19/094,572

(22) Filed: Mar. 28, 2025

Related U.S. Application Data
(60) Provisional application No. 63/664,647, filed on Jun. 26, 2024.

(51) Int. Cl. E06B 3/06; E06B 1/60

(52) U.S. Cl. CPC E06B 3/06; E06B 1/6015

(57) ABSTRACT

A fenestration system includes a frame member positionable within an opening defined in a building and adjacent a substrate of the building, the frame member including a plurality of bottom projections extending from the frame member and a foot extending laterally from at least one of the plurality of bottom projections, and a toggle shim arranged within a clearance defined between the frame member and the substrate, the toggle shim being securable to the substrate and including a securing device providing one or more engagement members engageable with the frame member. The toggle shim is transitionable between a disengaged position, where the one or more engagement members are disengaged from the foot, and an engaged position, where the one or more engagement members are engaged with the foot and thereby prevent the frame member from separating from the substrate.

### BACKGROUND

A “fenestration” refers to an architectural assembly or system designed to be installed in an opening of a building façade. Common fenestrations include doors, windows, sliding doors, and skylights. Fenestration systems typically include a frame sized to be installed in the building opening and include opposing top and bottom frame members, and opposing left and right side frame members that extend between the top and bottom frames. The opening defined by the frame members is generally filled with a door, a window, or another type of panel structure. In applications where the door, the window, or the panel is movable (e.g., slidable, pivotable, etc.), the door, the window, or the panel can be referred to as a movable “sash,” “vent,” or “leaf”.

As a movable sash in a fenestration system moves, the frame members that support the movable sash can have a tendency to twist or bend. For example, in a sliding door assembly, a sliding door is movably mounted to a rail provided by an underlying bottom frame member. Due to the weight of the sliding door, the bottom frame member may bend, twist, or separate from the underlying substrate as the sliding door moves between closed and open positions. As another example, in a pivoting door assembly, a pivoting door is movably mounted to a side frame member, and due to the weight of the pivoting door, the side frame member may have a tendency to bend, twist or separate from the adjacent substrate (e.g., a vertically extending substrate) as the pivoting door moves between closed and open positions.

What is needed is an assembly that helps prevent the frames member of movable sash fenestration systems from bending or twisting when the sash moves.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include a fenestration that includes a frame member positionable within an opening defined in a building and adjacent a substrate of the building, the frame member including a plurality of bottom projections extending from the frame member and a foot extending laterally from at least one of the plurality of bottom projections, and a toggle shim arranged within a clearance defined between the frame member and the substrate, the toggle shim being securable to the substrate and including a securing device providing one or more engagement members engageable with the frame member, wherein the toggle shim is transitionable between a disengaged position, where the one or more engagement members are disengaged from the foot, and an engaged position, where the one or more engagement members are engaged with the foot and thereby prevent the frame member from separating from the substrate. In a further embodiment, the substrate comprises a horizontal surface and the frame member comprises a bottom frame member resting on the horizontal surface. In another further embodiment, the substrate comprises a vertical surface and the frame member comprises a side frame member arranged vertically against the horizontal surface. In another further embodiment, the toggle shim comprises an elongate body having opposing first and second ends and opposing bottom and top surfaces extending between the first and second ends, the bottom surface resting against a top surface of the substrate, and a mechanical fastener extends through the first end and into the substrate to pivotably secure the toggle shim to the substrate. In another further embodiment, the toggle shim is transitioned from the disengaged position to the engaged position by rotating the toggle shim about an axis extending through the mechanical fastener and in a plane parallel to an upper surface of the substrate. In another further embodiment, the toggle shim includes a head provided at the first end and through which the mechanical fastener extends, the head including a base, and a stem extending vertically from the base, wherein the securing device is provided on an end of the stem and the one or more engagement members extend laterally outward from the stem such that a gap is defined between the base and the one or more engagement members to receive the foot when the toggle shim transitions to the engaged position. In another further embodiment, the securing device is extendable into a longitudinal groove defined between laterally adjacent bottom projections of the plurality of bottom projections, and each laterally adjacent bottom projection provides a foot extending laterally into the longitudinal groove, and the one or more engagement members comprise two engagement members arranged on opposite sides of the securing device and each engagement member is engageable with a corresponding foot of the laterally adjacent bottom projections when the toggle shim transitions to the engaged position. In another further embodiment, the second end of the body extends out of the clearance when the toggle shim is in the disengaged position. In another further embodiment, the toggle shim comprises a fixed member securable to the substrate and defining a slot, and a movable member that includes an elongate body having opposing first and second ends and opposing bottom and top surfaces extending between the first and second ends, the first end extending into the slot and the bottom surface resting against a top surface of the substrate, wherein the securing device is provided at the second end and the movable member is movable to transition the toggle shim between the disengaged and engaged positions. In another further embodiment, the toggle shim further includes a mating mechanism comprising one or more first protrusions provided by the fixed member and extending into the slot, and one or more second protrusions provided by the movable member and extending into the slot, wherein interaction between the one or more first and second protrusions maintains the toggle shim in the disengaged position until a lateral load is applied to the movable member such that the one or more second protrusions bypass the one or more first protrusions as the toggle shim moves to the engaged position. In another further embodiment, the securing device is extendable into a longitudinal groove defined between laterally adjacent bottom projections of the plurality of bottom projections, and wherein the one or more engagement members comprises a single engagement member engageable with the foot when the toggle shim transitions to the engaged position. In another further embodiment, wherein the toggle shim comprises a first fixed member that defines a recessed slot, a second fixed member received within the recessed slot and defining a recessed slide channel, wherein securing the second fixed member to the substrate simultaneously secures the first fixed member to the substrate, and a movable member received within the recessed slide channel and movable relative to the first and second fixed members, the movable member providing the securing device such that moving the movable member transitions the toggle shim between the disengaged and engaged positions. In another further embodiment, the first fixed member provides a substrate transition lip extendable over an end of the substrate to help properly orient a position the toggle shim relative to the substrate. In another further embodiment, the toggle shim further includes a mating mechanism comprising one or more arms provided by the movable member, a protrusion provided on an end of each arm, a plurality of pockets defined in the recessed slide channel and sized to receive and mate with the protrusion, interaction between the protrusion and the plurality of pockets maintains the toggle shim in the disengaged position until a lateral load is applied to the movable member such that the protrusion moves from a first pocket of the plurality of pockets to a second pocket of the plurality of pockets as the toggle shim moves to the engaged position. In another further embodiment, the securing device is extendable into a longitudinal groove defined between laterally adjacent bottom projections of the plurality of bottom projections, and wherein the one or more engagement members comprises a single engagement member engageable with the foot when the toggle shim transitions to the engaged position.

Embodiments disclosed herein further include a method of securing a frame member of a fenestration system, the method including the steps of securing a toggle shim to a substrate provided in an opening defined in a building, the toggle shim including a securing device providing one or more engagement members, positioning the frame member adjacent the substrate such that the toggle shim is arranged within a clearance defined between the frame member and the substrate, the frame member including a plurality of bottom projections extending from the frame member and a foot extending laterally from at least one of the plurality of bottom projections, transitioning the toggle shim from a disengaged position, where the one or more engagement members are disengaged from the foot, to an engaged position, where the one or more engagement members are engaged with the foot, and preventing the frame member from separating from the substrate with the toggle shim in the engaged position. In a further embodiment, the toggle shim comprises an elongate body having opposing first and second ends and a mechanical fastener extends through the first end and into the substrate to pivotably secure the toggle shim to the substrate, and wherein transitioning the toggle shim from the disengaged position to the engaged position comprises rotating the toggle shim about an axis extending through the mechanical fastener and in a plane parallel to an upper surface of the substrate. In another further embodiment, the one or more engagement members comprise two engagement members arranged on opposite sides of the securing device, and wherein positioning the frame member adjacent the substrate comprises receiving the securing device within a longitudinal groove defined between laterally adjacent bottom projections of the plurality of bottom projections, each laterally adjacent bottom projection providing a foot extending laterally into the longitudinal groove, and rotating the toggle shim until each engagement member engages with a corresponding foot of the laterally adjacent bottom projections. In another further embodiment, the toggle shim comprises a fixed member securable to the substrate and defining a slot, and a movable member extendable within the slot and having the securing device mounted thereto, and wherein transitioning the toggle shim from the disengaged position to the engaged position comprises moving the movable member relative to the fixed member until the one or more engagement members receive and are engaged with the foot. In another further embodiment, the toggle shim comprises a first fixed member that defines a recessed slot, a second fixed member received within the recessed slot and defining a recessed slide channel, and a movable member received within the recessed slide channel and movable relative to the first and second fixed members, the movable member providing the securing device, and wherein transitioning the toggle shim from the disengaged position to the engaged position comprises moving the movable member relative to the first and second fixed members until the one or more engagement members receive and are engaged with the foot.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIGS. 1A and 1B are front views of an example fenestration system that may incorporate the principles of the present disclosure.

FIGS. 2A and 2B are schematic diagrams of a prior art bottom frame member mounted to or otherwise resting on a substrate.

FIGS. 3A-3F depict an example toggle shim that may be used in accordance with the principles of the present disclosure.

FIGS. 4A-4D depict another example toggle shim that may be used in accordance with the principles of the present disclosure.

FIGS. 5A-5C depict another example toggle shim that may be used in accordance with the principles of the present disclosure.

FIGS. 6A-6B are schematic diagrams of a prior art side frame member mounted to a substrate.

FIGS. 7A and 7B depict another example toggle shim used in conjunction with a side frame member, in accordance with the principles of the present disclosure.

### DETAILED DESCRIPTION

The present disclosure is related to fenestration systems and, more particularly, to toggle shims capable of helping maintain a frame member secured to an adjacent substrate.

Embodiments described herein disclose a fenestration system that can include a frame member positionable within an opening defined in a building and adjacent a substrate of the building. The frame member may include a plurality of bottom projections extending from the frame member and a foot extending laterally from at least one of the plurality of bottom projections. A toggle shim may be arranged within a clearance defined between the frame member and the substrate. The toggle shim may be secured to the substrate and include a securing device providing one or more engagement members engageable with the frame member. The toggle shim may be transitionable between a disengaged position, where the one or more engagement members are disengaged from the foot, and an engaged position, where the one or more engagement members are engaged with the foot and thereby prevent the frame member from separating from the substrate.

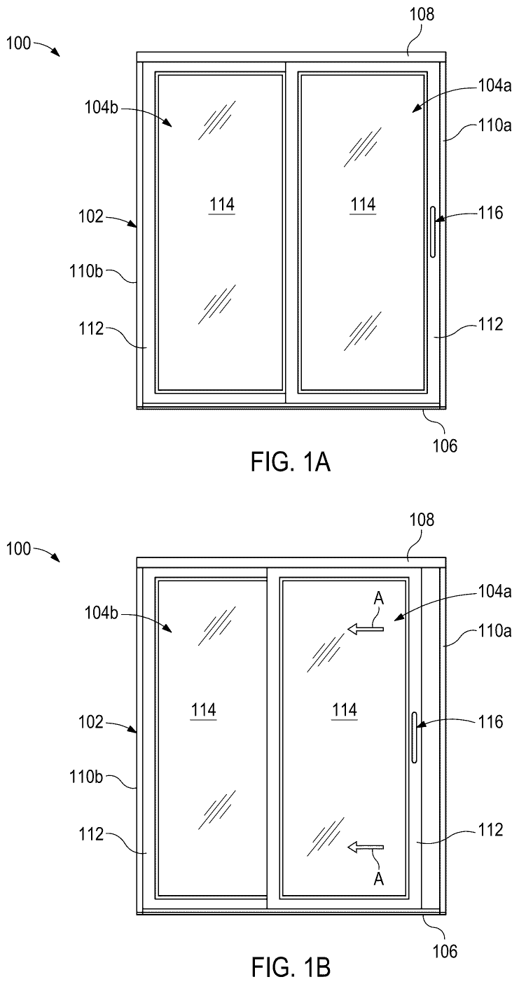

FIGS. 1A and 1B are front views of an example fenestration system 100 that may incorporate the principles of the present disclosure. The fenestration system 100 is depicted in FIGS. 1A-1B as a sliding door system and, therefore, will be referred to herein as the “sliding door system 100”. While the following description is directed to a sliding door assembly or system, the principles of the present disclosure are equally applicable to other types of fenestration systems including, but not limited to, swing doors, sliding windows, pivoting windows, curtain wall assemblies, conservatories, balconies, glazed roofing systems, storefront systems, or any combination thereof.

As illustrated, the sliding door system 100 (hereafter, “the system 100”) includes a door frame 102 that supports a sliding door panel 104a and a stationary door panel 104b. In other applications, the system 100 may include two sliding door panels that move relative to the other. The door frame 102 includes a bottom frame member 106, a top frame member 108 vertically offset from the bottom frame member 106, and opposing first and second side frame members 110a and 110b that extend vertically between the bottom and top frame members 106, 108. The door frame 102 is configured to be installed in an opening defined in any residential or commercial building, and the sliding and stationary door panels 104a,b may be installed in the door frame 102 to separate the outside (exterior) environment from the inside (interior) environment.

The sliding and stationary door panels 104a,b may each include a frame 112 that surrounds a discrete window pane or “infill” 114. The infills 114 may each comprise one or more panes of window glass, one or more panes of polycarbonate, or one or more panels of material that are clear, translucent, tinted, or opaque. Those skilled in the art will readily appreciate that other general designs and/or configurations for the sliding and stationary door panels 104a,b may alternatively be employed in the system 100, without departing from the scope of the disclosure. When in the closed position, the sliding door panel 104a may be substantially sealed about its periphery such that migration (leakage) of air, water, and/or debris about the perimeter of the door frame 102 is largely prevented.

The sliding door panel 104a is designed to move (e.g., slide, roll, translate, etc.) relative to the door frame 102 and the stationary door panel 104b, which remain static. FIG. 1A shows the system 100 in a closed position, where the sliding door panel 104a is closed and sealed, and FIG. 1B shows the system 100 moving (transitioning) to an open position, as indicated by the arrows A. The open position can be any position where the sliding door panel 104a has moved away from the first side frame member 110a and otherwise from the closed position. Moving the sliding door panel 104a to a “fully open” position refers to sliding or rolling the sliding door panel 104a away from the first side frame member 110a to its fullest extent.

To enable the sliding door panel 104a to slide or roll laterally (horizontally) relative to the frame 102, the sliding door panel 104a may include a plurality of internally mounted sliding assemblies (not shown). In some applications, the sliding assemblies may comprise wheels rotatably mounted on axles, but could alternatively comprise ball bearings, sliding assemblies that do not have wheels (e.g., wheel-less track systems), or any mechanism capable of assisting the sliding door panel 104a to slide (with or without a wheel) and/or roll horizontally relative to the frame 102. To help transition the sliding door panel 104a between the closed and open positions, the system 100 may further include a handle or handle assembly 116. A user (operator) can grasp the handle 116, provide a lateral force on the handle 116 in the direction A, and thereby move the sliding door panel 104a from the closed position to the open position in the direction A. The user can subsequently grasp the handle 116 to move the sliding door panel 104a from the open position back to the closed position, as desired.

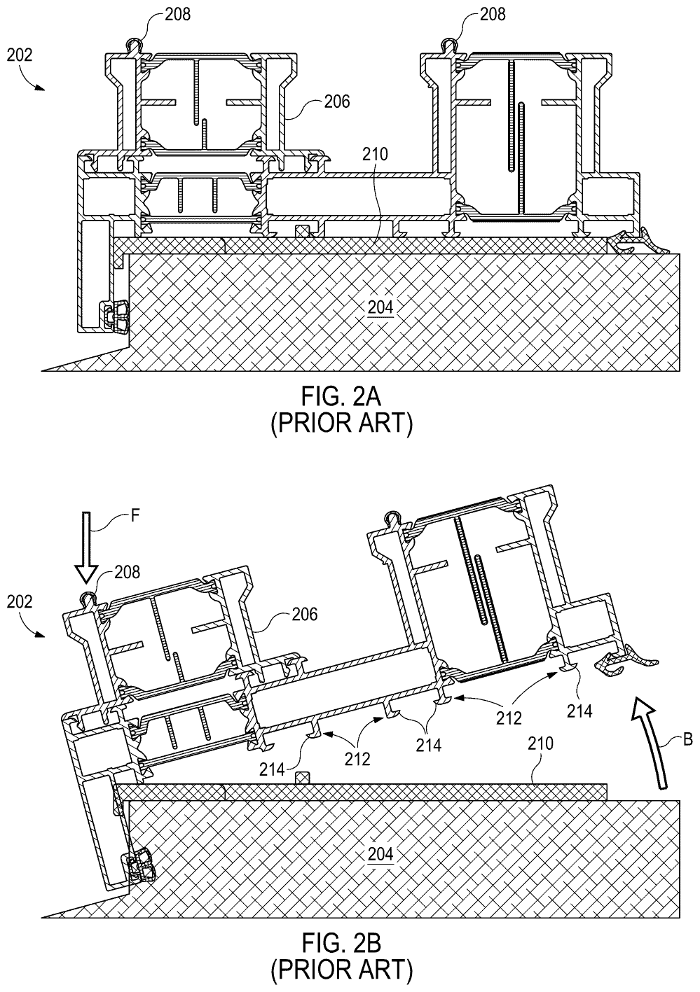

FIG. 2A is a schematic diagram of a prior art bottom frame member 202 mounted to or otherwise resting on a substrate 204. The bottom frame member 202 may be the same as or similar to the bottom frame member 106 of FIGS. 1A-1B. Accordingly, the bottom frame member 202 may be used in conjunction with the sliding door assembly 100 (FIGS. 1A-1B), but could alternatively be used with a variety of other types of fenestration systems that incorporate movable (e.g., sliding, pivoting, etc.) doors, windows, or panels.

As illustrated, the bottom frame member 202 includes a profile 206, which may comprise a rigid extrusion made primarily of aluminum, an aluminum alloy, other metals, metal alloys, a plastic (e.g., polyvinyl chloride), or any combination thereof. In applications where the bottom frame member 202 is used in conjunction with the sliding door assembly 100 (FIGS. 1A-1B), the profile 206 may provide one or more rails 208 configured to receive and seat corresponding sliding assemblies (not shown) for a sliding door panel (e.g., the sliding door panel 104a of FIGS. 1A-1B). The rails 208 may provide a smooth surface upon which the sliding assemblies are able to traverse to open or close the sliding door panel.

The substrate 204 may comprise a horizontal surface and any type of flooring or underlayment operable to support a fenestration system. In some applications, for example, the substrate 204 may comprise wood, but could alternatively comprise other rigid support materials such as concrete or a metal beam. In some applications, a shim 210 interposes at least a portion of the profile 206 and the substrate 204. The shim 210 may comprise a plurality of shims fixed to the substrate 204 at periodic intervals along the length of the substrate 204. The shims 210 are typically attached to the substrate 204 using screws. The shims 210 are used to position the profile 206 and may be made of a plastic or material that exhibits low thermal conductivity, thereby serving also as a thermal break between the substrate 204 and the profile 206.

FIG. 2B is a schematic diagram of the bottom frame member 202 bending, twisting, or otherwise deforming such that the bottom frame member 202 at least partially separates from the substrate 204. More specifically, in some applications, as a sliding door panel traverses one of the rails 208, a downward force F will be applied on the corresponding rail 208 and transferred to the profile 206. In other applications, the force F can be generated when the sliding door panel is first installed on the rail 208 and there is uneven load distribution. Such downward force F may cause the profile 206 to bend and otherwise separate from the substrate 204, as shown by the arrow B. In such cases, the profile 206 may dislodge from the substrate 204 or twist and deform, thereby resulting in an unusable window or sliding door.

According to embodiments of the present disclosure, one or more toggle shims (not shown) may be used to engage and secure the profile 206, and thereby prevent the profile 206 from bending, twisting, or otherwise separating (collectively referred to herein as “separating”) from the substrate 204. As illustrated, the profile 206 includes one or more bottom projections 212 (alternately referred to as “glazing bead grooves”) that extend from the bottom of the profile 206. The projections 212 may help support the profile 206 when resting on the substrate 204 (or the shim 210). Moreover, one or more of the projections 212 may include a laterally extending foot 214 that provides a surface or location where a toggle shim in accordance with the present disclosure can engage and secure the profile 206 against separating from the substrate 204.

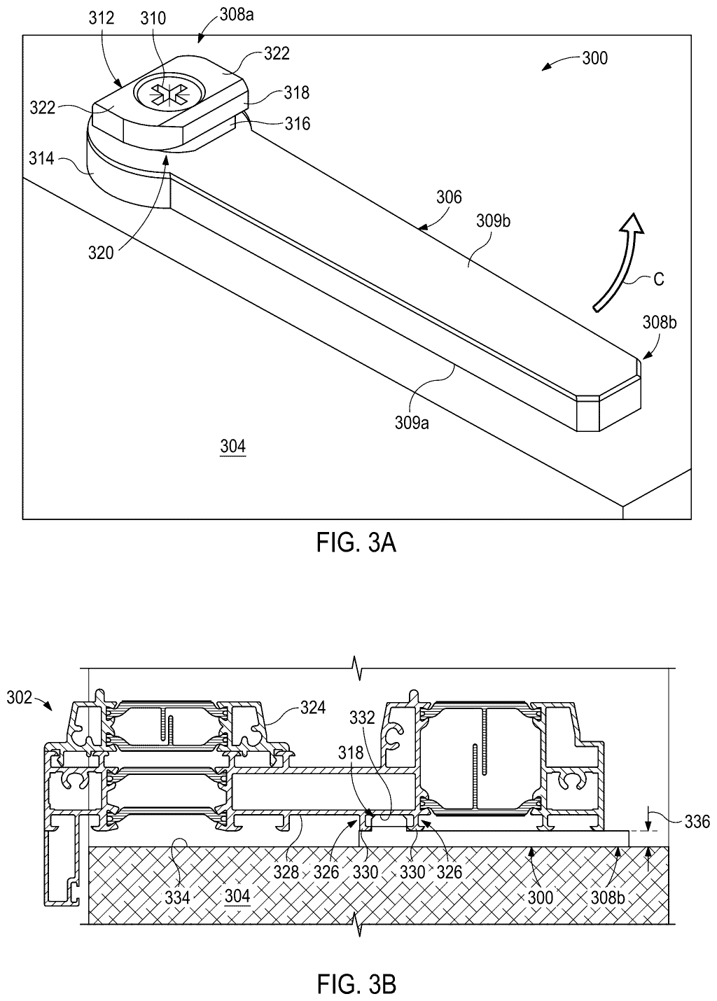

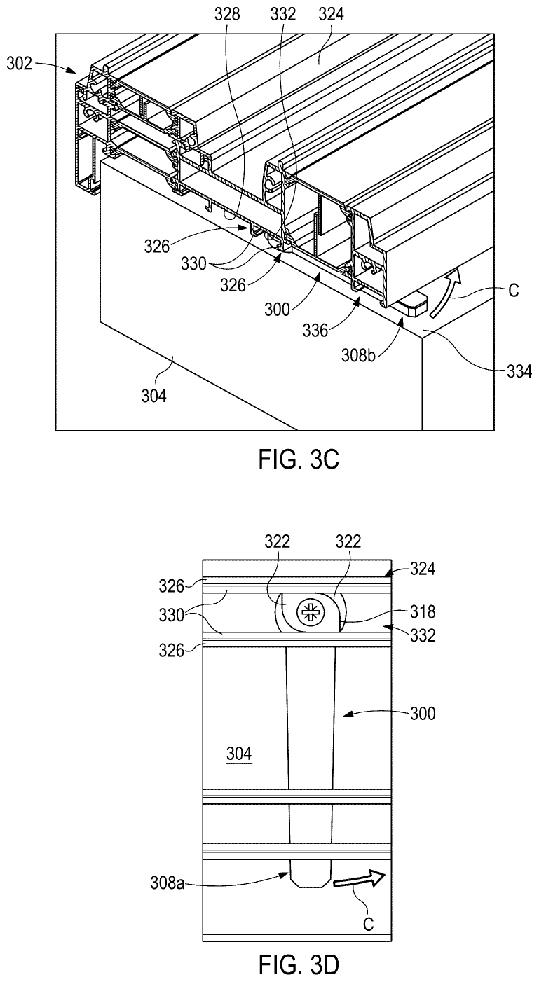

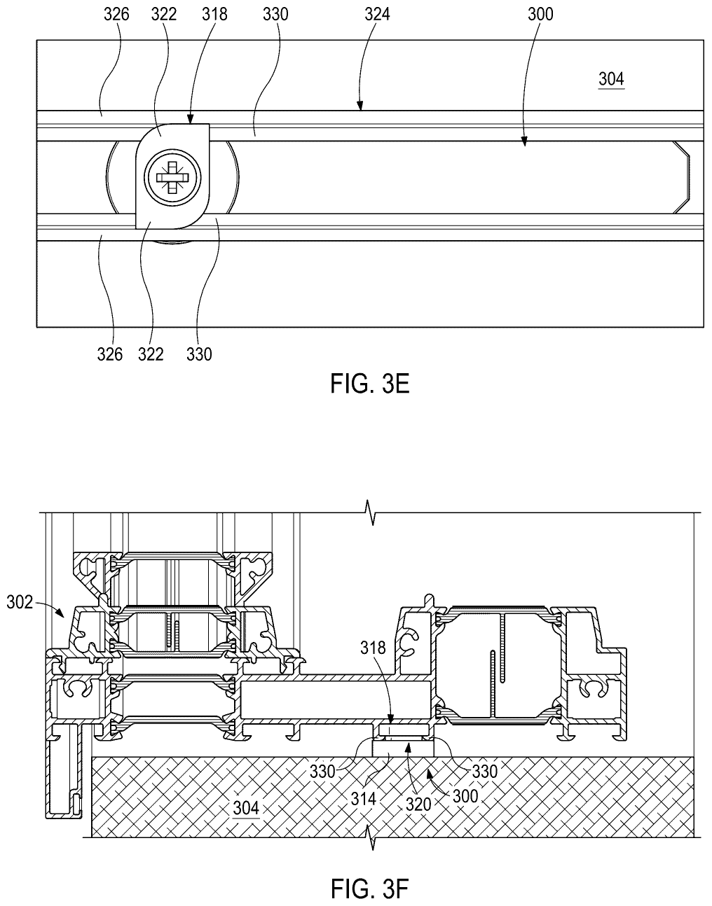

FIGS. 3A-3F depict an example toggle shim 300 that may be used in accordance with the principles of the present disclosure. The toggle shim 300, alternately referred to as a “toggle packer,” may be configured to interpose a bottom frame member 302 (FIGS. 3B, 3C, and 3F) and an underlying substrate 304. The bottom frame member 302 may be the same as or similar to the bottom frame member 202 of FIGS. 2A-2B, and the substrate 304 may be the same as or similar to the substrate 204 of FIGS. 2A-2B. Accordingly, in at least one embodiment, the toggle shim 300 may be used in the sliding door assembly 100 of FIGS. 1A-1B.

During installation, the bottom frame member 302 may at least partially rest on the toggle shim 300, and the toggle shim 300 may be manually manipulatable to engage and secure the bottom frame member 302 to the underlying substrate 304, as described below.

Referring first to FIG. 3A, as illustrated, the toggle shim 300 includes an elongate body 306 having opposing first and second ends 308a and 308b and opposing bottom and top surfaces 309a and 309b that extend between the first and second ends 308a,b. When installing the toggle shim 300, the bottom surface 309a rests against the top surface of the substrate 304. In some embodiments, the body 306 may exhibit a generally rectangular shape, but could alternatively exhibit other shapes, without departing from the scope of the disclosure. In at least one embodiment, the body 306 may taper in size (e.g., width) from the first end 308a to the second end 308b.

The toggle shim 300 may be movably secured to the substrate 304 with one or more mechanical fasteners 310 (one shown). The mechanical fastener 310 may comprise a screw, for example, but could alternatively comprise other types of mechanical fasteners. In some embodiments, as illustrated, the mechanical fastener 310 may extend through the first end 308a and into the underlying substrate 304 to movably (pivotably) secure the toggle shim 300 to the substrate 304. The mechanical fastener 310 may be installed such that the toggle shim 300 is suitably secured to the substrate 304 but able to rotate (pivot) about an axis extending through the mechanical fastener 310 and in a plane parallel to the upper surface of the substrate 304, as shown by the arrow C.

A head 312 may be provided and otherwise defined at the first end 308a and, in at least one embodiment, the head 312 may be enlarged as compared to remaining portions of the body 306. In some embodiments, as illustrated, the mechanical fastener 310 may be extended through the head 312. As illustrated, the head 312 includes a base 314, a stem 316 extending vertically from the base 314, and a securing device 318 provided on the end of the stem 316. The stem 316 exhibits a diameter or size that is smaller than both the base 314 and the securing device 318, thereby defining a gap 320 between the base 314 and the securing device 318.

As illustrated, the securing device 318 includes one or more engagement members 322 that extend laterally outward from the stem 316. In the illustrated embodiment, the securing device 318 includes two engagement members 322 provided and otherwise defined on opposite sides of the securing device 318, and the gap 320 is defined in the vertical space between the engagement members 322 and the top surface 309b of the body 306 at the base 314. The engagement members 322 may be operable to engage corresponding portions of the bottom frame member 302 (FIGS. 3B, 3C, and 3F) to thereby secure the bottom frame member 302 to the substrate 304. To accomplish this, the toggle shim 300 may be movable (pivotable) in the direction C between a first or “disengaged” position, where the engagement members 322 are disengaged from corresponding portions of the bottom frame member 302, and a second or “engaged” position, where the engagement members 322 are engaged with corresponding portions of the bottom frame member 302 and thereby prevent the bottom frame member 302 from separating from the substrate 304.

Referring now to FIGS. 3B and 3C, the bottom frame member 302 is depicted as mounted to the substrate 304 in conjunction with the toggle shim 300. As indicated above, the bottom frame member 302 may be the same as or similar to the bottom frame member 202 of FIGS. 2A-2B. For example, similar to the bottom frame member 202, the bottom frame member 302 includes a profile 324 and one or more bottom projections 326 extending from a bottom 328 of the profile 324. Moreover, one or more of the projections 326 may include a laterally extending projection or “foot” 330 that provides a surface or location where the toggle shim 300 can engage and secure the profile 324 against separating from the substrate 304.

As best seen in FIG. 3B, the securing device 318 of the toggle shim 300 extends into and is received within a longitudinal channel or “groove” 332 defined between laterally adjacent bottom projections 326, and each bottom projection 538 provides a foot 330 that extends laterally into the longitudinal groove 332 in opposing directions. The toggle shim 300 is movable (pivotable) between a disengaged position, where the securing device 318 is disengaged from the feet 330, and an engaged position, where the securing device 318 engages the feet 330 to prevent the profile 324 from separating from the substrate 304. The toggle shim 300 is shown in FIGS. 3B-3C in the disengaged position.

In some embodiments, when in the disengaged position, the toggle shim 300 is oriented perpendicular to the longitudinal direction of the bottom frame member 302. In such embodiments, moving (transitioning) the toggle shim 300 to the engaged position may entail pivoting the toggle shim 300 in the direction C (FIGS. 3A and 3C) until the toggle shim 300 is oriented parallel to the longitudinal direction of the bottom frame member 302. To reach the engaged position, the toggle shim 300 is pivoted in the direction C in a plane parallel to a top surface 334 of the substrate 304.

In some embodiments, as illustrated, the profile 324 may be mounted to the substrate 304 such that a clearance 336 is defined vertically between the profile 324 and the top surface 334 of the substrate 304. The second end 308a of the toggle shim 300 may extend out from underneath the profile 324 via the clearance 336. To transition the toggle shim 300 from the disengaged position to the engaged position, the second end 308a of the toggle shim 300 may be pivoted in the direction C into the clearance 336 and otherwise underneath the profile 324. In at least one embodiment, the toggle shim 300 may be rotated about 90° to transition to the engaged position, but the toggle shim 300 may alternatively be designed to be rotated more or less than 90° to reach the engaged position, without departing from the scope of the disclosure.

In some embodiments, transitioning the toggle shim 300 between the disengaged and engaged positions may be done manually by a user (installer). In such embodiments, the installer may use a screwdriver or another thin and long instrument to engage and place a lateral load on the second end 308a of the toggle shim 300. The lateral load may be applied on the second end 308a in the direction C until the toggle shim 300 is pivoted fully to the engaged position, and otherwise to a position where the securing device 318 is properly engaged with the feet 330.

Referring now to FIGS. 3D and 3E, illustrated are enlarged top views of the toggle shim 300 showing an example transitioning between the disengaged and engaged positions, respectively. In the disengaged position, as shown in FIG. 3D, the securing device 318 is received within the groove 332 but is disengaged from the profile 324. More specifically, in the disengaged position, the engagement members 322 of the securing device 318 are disengaged from the feet 330 provided by the opposing bottom projections 326. In the illustrated embodiment, the feet 330 extend laterally into the groove 332. Moreover, in the disengaged position, the second end 308a of the toggle shim 300 extends out from beneath the profile 324, thus providing a user with a location to engage and pivot the toggle shim 300 to the engaged position in the direction C. This also provides the user with a visual indication that the toggle shim 300 is in the disengaged position.

In the engaged position, as shown in FIG. 3E, the toggle shim 300 has been rotated approximately 90° from the disengaged position, thereby allowing the securing device 318 to engage with the profile 324. More specifically, in the engaged position the engagement members 322 extend over and are otherwise engaged with the feet 330, thereby preventing the profile 324 from separating from the substrate 304.

FIG. 3F is a schematic side view of the toggle shim 300 in the engaged position where the bottom frame member 302 is locked in place relative to the substrate 304. As illustrated, when the securing device 318 is moved to the engaged position, the feet 330 are received within the gap 320 defined between the base 314 and the securing device 318.

The toggle shim 300 may be made of a variety of rigid materials including, but not limited to, a metal, a metal alloy, a polymer (plastic), a composite material, wood, or any combination thereof. In some embodiments, the toggle shim 300 may be made of a thermally low-conductive material, such as a polymer or a composite material. In such embodiments, the toggle shim 300 may also operate and otherwise serve as a thermal break.

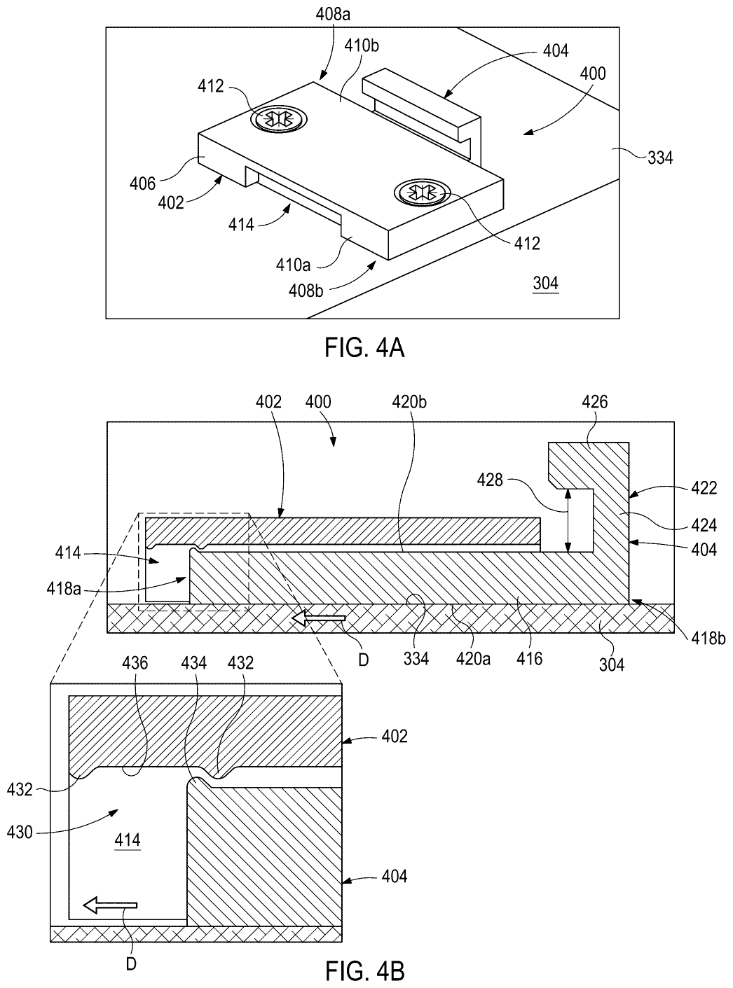

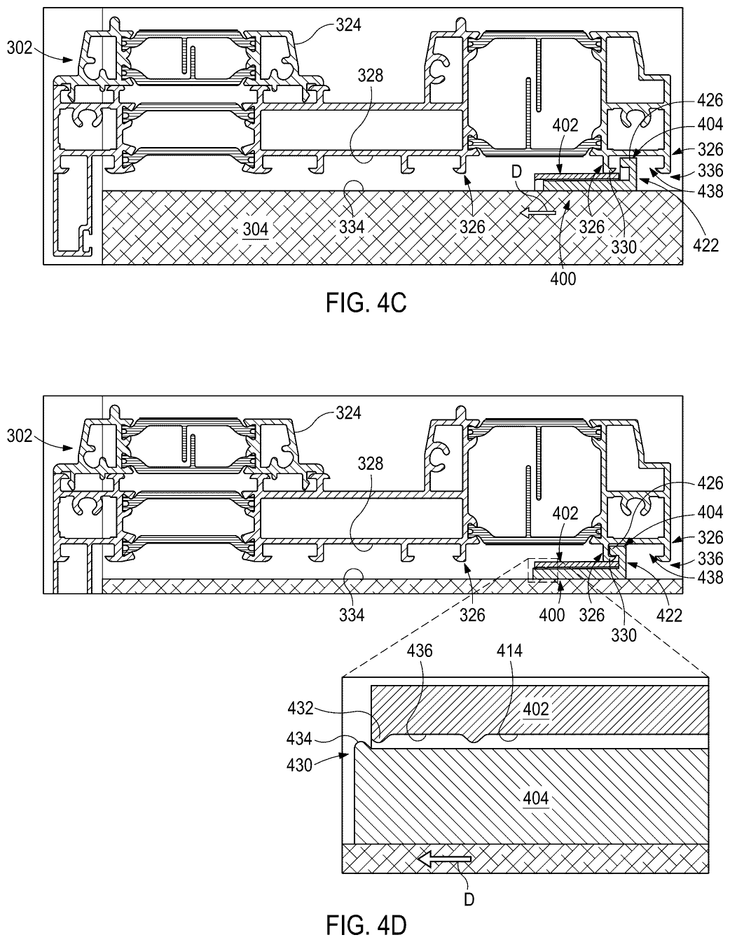

FIGS. 4A-4D depict another example toggle shim 400 that may be used in accordance with the principles of the present disclosure. Similar to the toggle shim 300 of FIGS. 3A-3F, the toggle shim 400 may be manually manipulatable to engage and secure the bottom frame member 302 (FIGS. 4C and 4D) to the underlying substrate 304. Accordingly, in at least one embodiment, the toggle shim 400 may be used in the sliding door assembly 100 of FIGS. 1A-1B. Unlike the toggle shim 300, however, the toggle shim 400 may comprise and otherwise include multiple component parts.

Referring first to FIG. 4A, as illustrated, the toggle shim 400 includes a first or “fixed” member 402 and a second or “movable” member 404. The fixed member 402 may include an elongate body 406 having opposing first and second ends 408a and 408b and opposing bottom and top surfaces 410a and 410b. The top surface 410b extends uninterrupted between the first and second ends 408a,b, but the bottom surface 410b defines a slot 414 sized to receive a portion of the movable member 404 as described in more detail below. The body 406 may exhibit a generally rectangular shape, but could alternatively exhibit other shapes, without departing from the scope of the disclosure. When installing the toggle shim 400, portions of the bottom surface 410a may rest against the top surface 334 of the substrate 304.

The fixed member 402 may be secured to the substrate 304 with one or more mechanical fasteners 412 (two shown), such as a screw or the like. In the illustrated embodiment, two mechanical fasteners 412 are used to secure the fixed member 402 to the substrate 304 and extend through the body 406 near the opposing first and second ends 408a,b and into the underlying substrate 304.

Referring to FIG. 4B, illustrated is a cross-sectional side view of the toggle shim 400, according to one or more embodiments. As illustrated, the movable member 400 provides an elongate body 416 having opposing first and second ends 418a and 418b and opposing bottom and top surfaces 420a and 420b that extend between the first and second ends 418a,b. When installing the toggle shim 400, a large portion of the body 416 is received within the slot 414 defined by the fixed member 402, and the bottom surface 420a rests against the top surface 334 of the substrate 304.

In some embodiments, as illustrated, a securing device 422 may be provided at or near the second end 418b of the movable member 404 and is operable to secure the bottom frame member 302 (FIGS. 4C and 4D) to the substrate 304. More specifically, as illustrated, the securing device 422 may include a stem 424 that extends vertically from the body 416 and terminates with one or more engagement members 426 (one shown). The engagement member 426 extends laterally outward from the stem 424, thereby defining a gap 428 between the top surface 420b of the body 406 and the engagement member 426. The gap 428 may prove advantageous in receiving a portion of the bottom frame member 302, and thereby allowing the engagement member 426 to secure the bottom frame member 302 (FIGS. 4C and 4D) against the substrate 304.

More specifically, the toggle shim 400 may be transitionable between a first or “disengaged” position, where the engagement member 426 is disengaged from a corresponding portion of the bottom frame member 302, and a second or “engaged” position, where the engagement member 426 is engaged with a corresponding portion of the bottom frame member 302, and thereby preventing the bottom frame member 302 from separating from the substrate 304. Transitioning the toggle shim 400 between the disengaged and engaged positions comprises moving the movable member 404 laterally relative to the fixed member 402 in the direction D, and thereby advancing the body 416 of the movable member 404 deeper into the slot 414.

In some embodiments, as illustrated in the enlarged inset graphic of FIG. 4B, the toggle shim 400 may further include a mating mechanism 430 that temporarily mates the fixed and movable members 402, 404 and helps maintain the toggle shim 400 in the disengaged or engaged positions until an installer manually manipulates the toggle shim 400. In some embodiments, as illustrated, the mating mechanism 430 may include one or more first protrusions 432 provided by the fixed member 402 and extending vertically downward and into the slot 414, and one or more second protrusions 434 provided by the movable member and extending vertically upward from the top surface 420b and into the slot 414. In the illustrated embodiment, the mating mechanism 430 includes two first protrusions 432 laterally separated (spaced) from each other and thereby defining a recess 436, and one second protrusion 434 positioned to interact with the first protrusions 432. As will be appreciated, however, in alternative embodiments, the first protrusions 432 may be provided on the movable member 404, and the second protrusion 434 may be provided on the fixed member 402, without departing from the scope of the disclosure.

When the toggle shim 400 is installed, the second protrusion 434 will be arranged (located) between the first protrusions 432 and otherwise within the recess 436, which will help maintain the movable member 404 relative to the fixed member 402. Receiving the second protrusion 434 within the recess 436 however, may also help maintain the toggle shim 400 in the disengaged position. Engaging the second protrusion 434 against either of the first protrusions 432 may result in an interference obstruction that prevents the second protrusion 434 from bypassing the first protrusion 432 until a sufficient lateral load is applied. Once the sufficient lateral load is applied, the second protrusion 434 can advance past the first protrusion 432 by elastically deforming the fixed member 404. Advancing the movable member 404 laterally in the direction D, such that the second protrusion 434 transitions out of the recess 436, allows the toggle shim 400 to transition to the engaged position.

It should be noted, however, that the mating mechanism 430 may be provided in a variety of different architectures or designs, without departing from the scope of the disclosure. More specifically, while the mating mechanism 430 is depicted herein as including the first and second matable protrusions 432, 434, it is contemplated herein to temporarily mate the fixed and movable members 402, 404 with other types of temporary mating mechanisms including, but not limited to, a magnetic interface, a frangible member (e.g., a shear pin or shear screw), a releasable adhesive, or any combination thereof.

Referring now to FIGS. 4C and 4D, the bottom frame member 302 is depicted mounted to the substrate 304 in conjunction with the toggle shim 400. As illustrated, the bottom frame member 302 includes the bottom projections 326 extending from the bottom 328 of the profile 324, and at least one of the projections 326 includes a laterally extending foot 330 that provides a surface or location where the toggle shim 400 can engage and secure the profile 324 against separating from the substrate 304.

In the illustrated embodiment, the securing device 422 of the toggle shim 400 extends into and is received within a longitudinal channel or “groove” 438 defined between laterally adjacent bottom projections 326, and at least one of the bottom projections 326 provides a foot 330 that extends laterally into the longitudinal groove 438. The toggle shim 400 is movable between a disengaged position, where the securing device 422 is disengaged from the foot 330, and an engaged position, where the securing device 422 engages the foot 330 to prevent the profile 324 from separating from the substrate 304.

The toggle shim 400 is shown in FIG. 4C in the disengaged position, and shown in FIG. 4D in the engaged position. The toggle shim 400 is moved from the disengaged position to the engaged position by advancing the movable member 404 in a plane parallel to the top surface 334 of the substrate 304 and relative to the fixed member 402 in the direction D (FIG. 4C). As illustrated, the profile 324 may be mounted to the substrate 304 such that the clearance 336 is defined vertically between the profile 324 and the top surface 334 of the substrate 304. To transition the toggle shim 400 from the disengaged position to the engaged position, a user (installer) may insert a screwdriver or another thin and long instrument into the clearance 336 to engage and place a lateral load on the movable member 404 in the direction D.

The lateral load may be applied on the movable member 404 until the toggle shim 400 is pivoted fully to the engaged position. More specifically, the lateral load is applied on the movable member 404 until the securing device 422 (e.g., the engagement member 426) is properly engaged with the foot 330. As the movable member 404 advances in the direction D, the foot 330 is received within the gap 428 (FIG. 4B), thereby allowing the engagement member 426 to be received above the foot 330.

With reference to the enlarged, inset graphic of FIG. 4D, transitioning the toggle shim 400 from the disengaged position to the engaged position may also affect the mating mechanism 430. More specifically, as the movable member 404 advances laterally in the direction D, the second protrusion 434 will eventually locate and engage the first protrusion 432 located at or near the opening to the slot 414. Increased lateral load in the direction D will force the second protrusion 434 to bypass the first protrusion 432 by elastically deforming the material of the fixed member 402. Once the second protrusion 434 advances out of the recess 436, the toggle shim 400 will be transitioned to the engaged position, as generally described above.

The toggle shim 400 may be made of any of the materials mentioned above for the toggle shim 300 of FIGS. 3A-3F. Moreover, the toggle shim 400 may serve a dual purpose as a thermal break if made of a thermally low-conductive material.

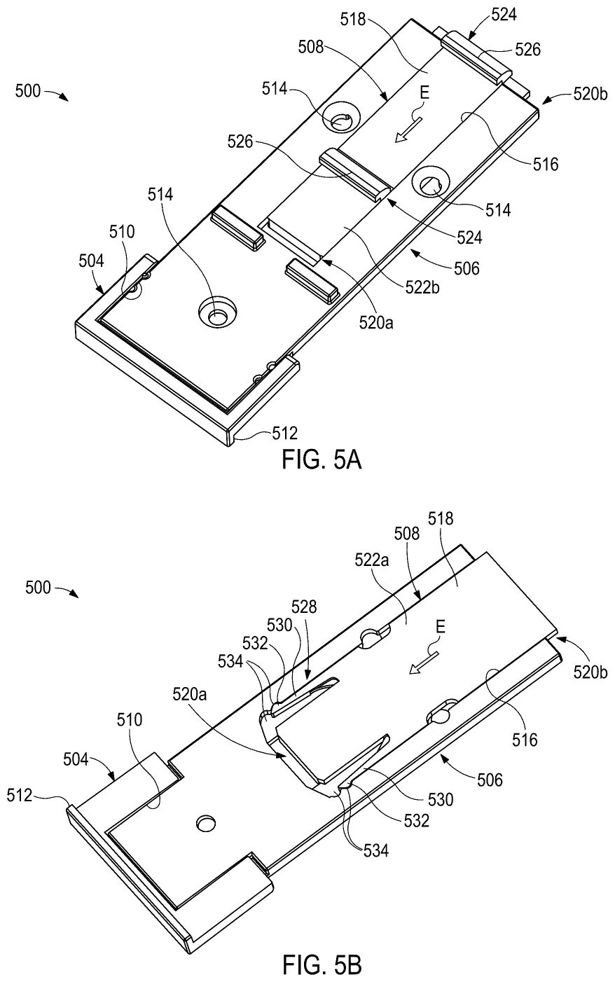

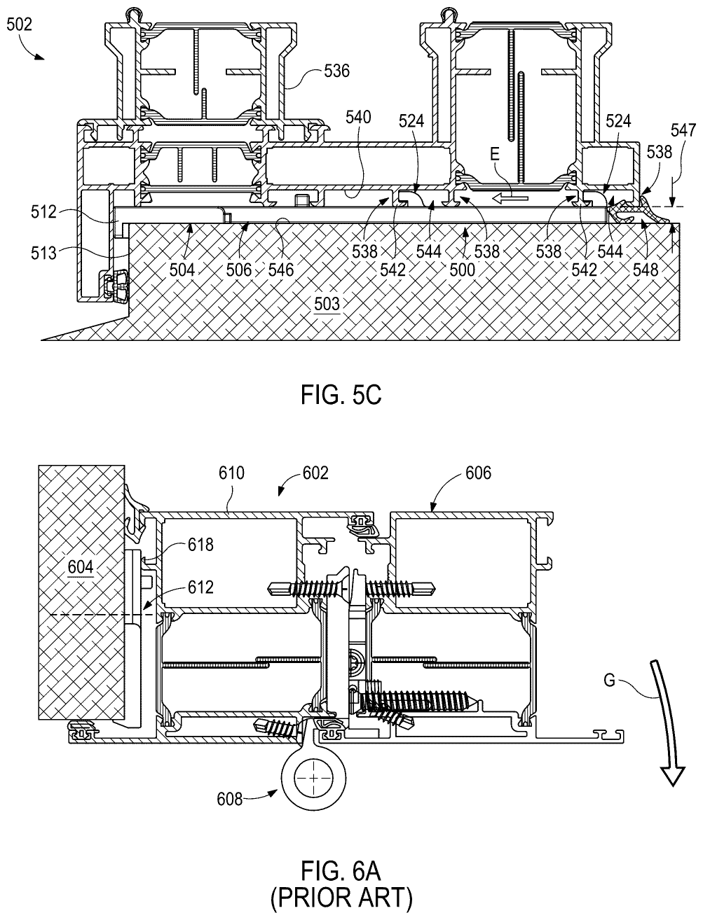

FIGS. 5A-5C depict another example toggle shim 500 that may be used in accordance with the principles of the present disclosure. Similar to the other toggle shims 300, 400 described herein, the toggle shim 500, may be manually manipulatable to engage and secure a bottom frame member 502 (FIG. 5C) to an underlying substrate 503 (FIG. 5C). The bottom frame member 502 may be the same as or similar to the bottom frame member 202 of FIGS. 2A-2B, and the substrate 503 may be the same as or similar to the substrate 204 of FIGS. 2A-2B. Accordingly, the toggle shim 500 may be used in the sliding door assembly 100 of FIGS. 1A-1B.

Unlike the toggle shims 300 and 400, however, the toggle shim 500 may comprise and otherwise include three component parts.

Referring first to FIGS. 5A and 5B, illustrated are top and bottom isometric views, respectively, of the toggle shim 500. As illustrated, the toggle shim 500 includes a first fixed member 504, a second fixed member 506, and a movable member 508 configured to move relative to the first and second fixed members 504, 506 to thereby secure the bottom frame member 502 (FIG. 5C) to the substrate 503 (FIG. 5C).

The first fixed member 504 provides and otherwise defines a recessed slot 510 sized to receive and seat an end of the second fixed member 506. In at least one embodiment, as illustrated, the recessed slot 510 provides at least one transition such that a larger (widthwise) portion of the second fixed member 506 is received within a top portion of the recessed slot 510, as shown in FIG. 5A, and a smaller (widthwise) portion of the second fixed member 506 received within a bottom portion of the recessed slot 510, as shown in FIG. 5B.

The first fixed member 504 may further provide and otherwise define a substrate transition lip 512 sized and otherwise configured to extend over an end 513 (FIG. 5C) of the substrate 503. The substrate transition lip 512 help properly orient a position the toggle shim 500 relative to the substrate 503, thus enabling the toggle shim 500 to properly support some or all of the bottom frame member 502 (FIG. 5C).

The second fixed member 504 may define one or more apertures 514 sized to receive a corresponding one or more mechanical fasteners (not shown). The mechanical fasteners may be the same as or similar to the mechanical fasteners 310, 412 described herein, and therefore will not be described again in detail. In the illustrated embodiment, three apertures 514 are provided in the second fixed member 504, but more less than three apertures 514 may be included, without departing from the scope of the disclosure. Installing mechanical fasteners in the apertures 514 serves to secure the toggle shim 500 to the underlying substrate 503, and thereby simultaneously securing the first fixed member 504 to the substrate 503.

The varying widths of the second fixed member 506 at the recessed slot 510 allows the second fixed member 506 to simultaneously secure the first fixed member 504 to the substrate 503 (FIG. 5C) when the second fixed member 506 is secured to the substrate 503 with the mechanical fasteners. The varying widths of the second fixed member at the recessed slot 510 also allows an installer (user) to adjust the lateral position of both fixed members 504, 506 prior to fixing the fixed members 504, 506 to the substrate 503. More specifically, the second fixed member 506 may be moved laterally relative to the first fixed member 504 until achieving a desired position, which pointed the mechanical fasteners may be used to fix both fixed members 504, 506 to the substrate 503.

The second fixed member 504 may further provide and otherwise define a recessed slide channel 516 sized to receive the movable member 508. Similar to the recessed slot 510, the recessed slide channel 516 may provide at least one transition such that a smaller (widthwise) portion of the movable member 508 is received within a top portion of the recessed slide channel 516, as shown in FIG. 5A, and a larger (widthwise) portion of the movable member 508 received within a bottom portion of the recessed slide channel 516, as shown in FIG. 5B.

The movable member 508 may provide an elongate body 518 having opposing first and second ends 520a and 520b and opposing bottom and top surfaces 522a and 522b that extend between the first and second ends 520a,b. When installing the toggle shim 500, the bottom surface 522a rests against the top surface of the substrate 503 (FIG. 5C).

As best seen in FIG. 5A, one or more securing devices 524 (two shown) may be provided on the top surface 522b of the movable member 508, and are operable to secure the bottom frame member 502 (FIG. 5C) to the substrate 503. More specifically, the securing devices 524 may each extend vertically from the top surface 522b of the body 518 and terminate with an engagement member 526. Each engagement member 526 extends laterally, and thereby defines a gap between the top surface 522b and the engagement member 526. The gap may be configured to receive a portion of the bottom frame member 502 as the movable member 508 is moved relative to the fixed members 504, 506.

As best seen in FIG. 5B, the toggle shim 500 may further include a mating mechanism 528 that temporarily mates the movable member 508 to the second fixed member 506 and helps maintain the toggle shim 500 in the disengaged and engaged positions. In some embodiments, as illustrated, the mating mechanism 528 may include one or more arms 530 provided and otherwise defined by the movable member 508 at or near the first end 520a. Each arm 530 may terminate in a protrusion 532 configured to locate and be received within corresponding pockets 534 defined in the recessed slide channel 516 of the second fixed member 506. In the illustrated embodiment, the mating mechanism 528 includes two arms 530 and two pockets 534 are defined on each side of the recessed slide channel 516 to receive the protrusions 532 as the movable member 508 shifts relative to the second fixed member 506. As will be appreciated, however, in alternative embodiments, the protrusions 532 may alternatively be defined in the recessed slide channel 516 and the pockets 534 may alternatively be defined on the arms 530, without departing from the scope of the disclosure.

When the toggle shim 500 is installed, the protrusions 532 will be arranged in corresponding first pockets 534, which will help maintain the movable member 508 relative to the fixed members 504, 506. The toggle shim 500 is shown in FIGS. 5A-5B in the disengaged position, and moving the toggle shim 500 to the engaged position entails laterally moving the movable member 508 relative to the fixed members 504, 506 in the direction E. As the toggle shim 500 is transitioned to the engaged position in the direction E, the arms 530 flex laterally inward and the protrusions 532 are forced out of engagement with the first pockets 534 (i.e., pockets 534 further from the first end 520a). Further movement of the movable member 508 in the direction E allows the protrusions 532 to locate and be received within the second pockets 534 (i.e., pockets 534 closer to the first end 520a). When the protrusions 532 are received within the second pockets 534, the toggle shim 500 is effectively transitioned to the engaged position.

Similar to the mating mechanism 430 of FIGS. 4B and 4D, it should be noted that the mating mechanism 528 may alternatively be provided in a variety of different architectures or designs, without departing from the scope of the disclosure, such as any of the alternative designs mentioned above with respect to the mating mechanism for 30.

Referring now to FIG. 5C, the bottom frame member 502 is depicted mounted to the substrate 503 in conjunction with the toggle shim 500. As indicated above, the bottom frame member 502 may be the same as or similar to the bottom frame member 202 of FIGS. 2A-2B and, therefore, includes a profile 536 that provides the one or more bottom projections 538 extending from a bottom 540 of the profile 536. Moreover, one or more of the projections 538 may include a laterally extending foot 542 that provides a surface or location where the toggle shim 500 can engage and secure the profile 536 against separating from the substrate 503.

In the illustrated embodiment, the securing devices 524 of the toggle shim 500 extend into and are received within discrete longitudinal channels or “grooves” 544 defined between laterally adjacent bottom projections 538, and at least one of the bottom projections 538 that helps define the longitudinal groove 544 provides a foot 542 that extends laterally into the longitudinal groove 544. The toggle shim 500 is movable between a disengaged position, where the securing devices 524 are disengaged from the adjacent feet 542, and an engaged position, where the securing devices 524 engage the adjacent feet 542 and thereby prevent the profile 536 from separating from the substrate 503.

The toggle shim 500 is moved from the disengaged position to the engaged position by advancing the movable member 508 (FIGS. 5A-5B) in a plane parallel to a top surface 546 of the substrate 503 and relative to the fixed members 504, 506 in the direction E. As illustrated, the profile 536 may be mounted to the substrate 503 such that a clearance 547 is defined vertically between the profile 536 and the top surface 546 of the substrate 503. To transition the toggle shim 500 from the disengaged position to the engaged position, a user (installer) may insert a screwdriver or another thin and long instrument into the clearance 547 to engage and place a lateral load on the movable member 508 in the direction E. The lateral load may be applied on the movable member 508 until the toggle shim 500 is moved fully to the engaged position and, more specifically, until the securing devices 524 (e.g., the engagement members 526) are properly engaged with the adjacent foot 542.

Moreover, transitioning the toggle shim 500 from the disengaged position to the engaged position may also adjust the mating mechanism 528 (FIG. 5B), as generally described above.

In some embodiments, once the toggle shim 500 is moved to the engaged position, a gasket 548 may be installed within the clearance 547. If the gasket 548 is able to be properly installed within the clearance 547, this may be an indication that the toggle shim 500 is properly placed in the engaged position. In contrast, if the gasket 548 is unable to be properly installed in the clearance 547, that may indicate that the toggle shim 500 remains in the disengaged position and the bottom frame member 502 is not properly secured to the substrate 503.

The toggle shim 500 may be made of any of the materials mentioned above for the toggle shim 300 of FIGS. 3A-3F. Moreover, as with the above-described toggle shims 300, 400, the toggle shim 500 may serve a dual purpose as a thermal break if made of a thermally low-conductive material.

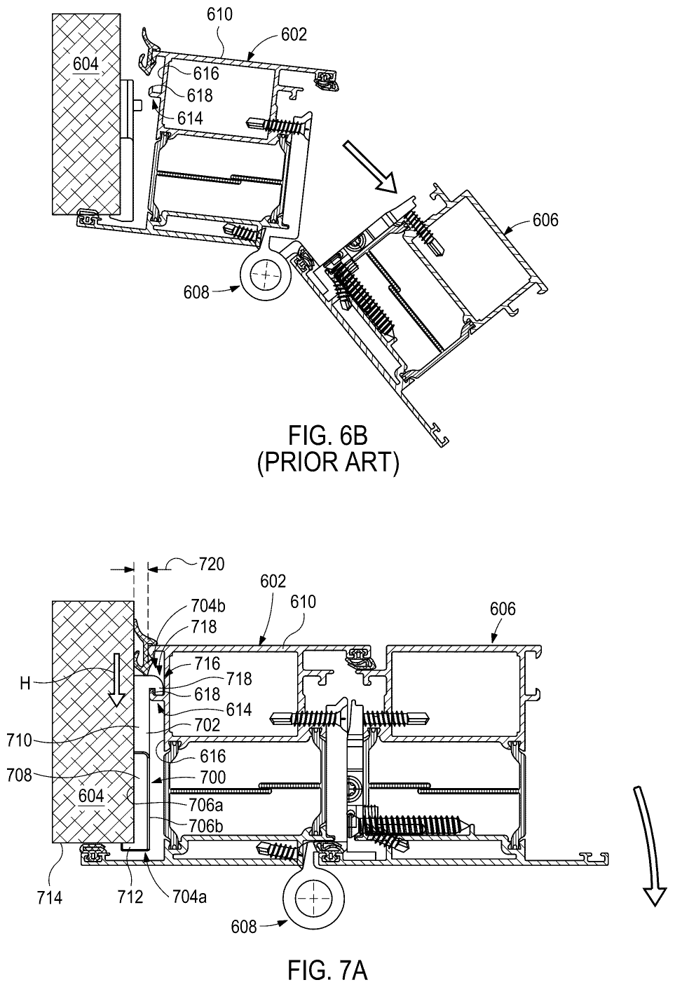

FIG. 6A is a schematic diagram of a prior art side frame member 602 mounted to a substrate 604. More specifically, FIG. 6A is a top, cross-sectional view of the side frame member 602 and the substrate 604. The side frame member 602 may comprise, for example, a side frame member for a door or window frame, and the substrate 604 may comprise a vertical member that defines an opening to a building to receive a pivoting door or window assembly. A vertical stile 606 may be pivotably mounted to the side frame member 602 at a hinge 608. The vertical stile 606 may comprise a vertical stile member for a door or a window, and the hinge 608 may allow the door or window to pivot between open and closed positions relative to the side frame member 602, as shown by the arrow G. Accordingly, FIG. 6A may depict a prior art pivoting door or window assembly.

As illustrated, the side frame member 602 includes a profile 610, which may comprise a rigid extrusion made primarily of aluminum, an aluminum alloy, or other metals and metal alloys. The substrate 604 may comprise wood, but could alternatively comprise other rigid support materials such as concrete or a metal beam. In some applications, a shim 612 interposes at least a portion of the profile 610 and the substrate 604.

FIG. 6B is a schematic diagram of the side frame member 602 bending, twisting, or otherwise deforming such that the side frame member 602 at least partially separates from the substrate 604. As a pivoting door or window attached to the vertical stile 606 pivots to the open position at the hinge 608, an outward force will be applied on the profile 610, which could cause the profile 610 to bend and otherwise separate from the substrate 604.

According to embodiments of the present disclosure, a toggle shim (e.g., any of the toggle shims 300, 400, 500 described herein) may be used to engage and secure the profile 610, and thereby prevent the profile 610 from bending, twisting, or otherwise separating (collectively referred to herein as “separating”) from the substrate 604. As illustrated, the profile 610 includes one or more bottom projections 614 that extend from a bottom 616 of the profile 610. The projections 614 may help support the profile 610 when resting on the substrate 604 (or the shim 612), but may also provide a laterally extending foot 618 that provides a surface or location where the toggle shim can engage and secure the profile 610 against separating from the substrate 604.

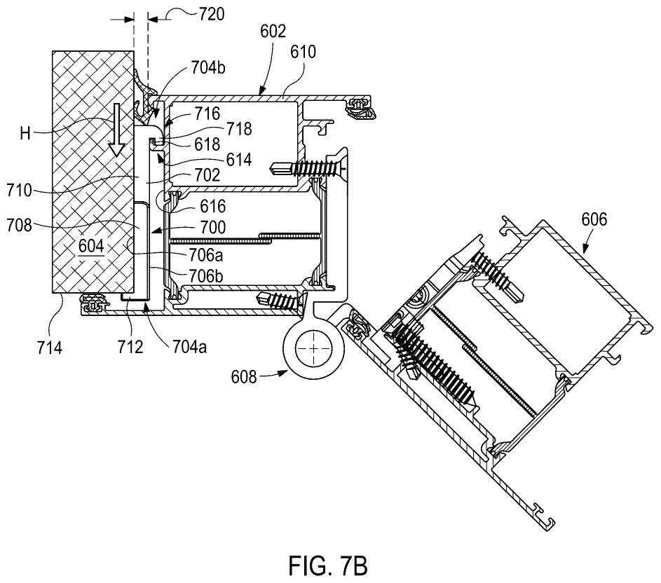

FIGS. 7A and 7B depict an example toggle shim 700 used in conjunction with the side frame member 602, in accordance with the principles of the present disclosure. More specifically, FIG. 7A depicts the vertical stile 606 in a closed position and arranged adjacent the side frame member 602, and FIG. 7B depicts the vertical stile 606 pivoting away from the side frame member 602 at the hinge 608 and otherwise to an open position.

The toggle shim 700 may be the same as or similar to any of the toggle shims 300, 400, 500 described herein, and therefore may be best understood with reference thereto. In the illustrated embodiment, the toggle shim 700 includes an elongate body 702 having opposing first and second ends 704a and 704b and opposing bottom and top surfaces 706a and 706b that extend between the first and second ends 704a,b. When installing the toggle shim 700, the bottom surface 706a rests against the substrate 604. In some embodiments, the body 702 may exhibit a generally rectangular shape, but could alternatively exhibit other shapes, without departing from the scope of the disclosure.

The toggle shim 700 may provide a fixed member 708 and a movable member 710 that is movable relative to the fixed member 708. The fixed member 708 may provide and otherwise define a substrate transition lip 712 at or near the first end 704. The substrate transition lip 712 may be sized and otherwise configured to extend over an end 714 (e.g., a sidewall) of the substrate 604 to help properly orient a position the toggle shim 700 relative to the substrate 604.

A securing device 716 may be provided at or near the second end 704b of the toggle shim 700 and forming part of the movable member 710. The securing device 716 may be operable to secure the side frame member 602 to the substrate 604. As illustrated, the securing device 716 extends vertically from the top surface 706b of the body 702 and terminates with one or more engagement members 718 (one shown). The engagement member 718 extends laterally outward and thereby defines a gap between the top surface 706b of the body 702 and the engagement member 718. The gap may prove advantageous in receiving a portion of the side frame member 602, and thereby allowing the engagement member 718 to secure the side frame member 602 against the substrate 604.

The toggle shim 700 may be transitionable between a first or “disengaged” position, where the engagement member 718 is disengaged from a corresponding portion of the side frame member 602, and a second or “engaged” position, where the engagement member 718 is engaged with a corresponding portion of the side frame member 602, and thereby prevents the side frame member 602 from separating from the substrate 604. Transitioning the toggle shim 700 between the disengaged and engaged positions comprises moving the movable member 710 laterally relative to the fixed member 708 in the direction H, and thereby advancing the movable member 710 relative to the fixed member 708.

As illustrated, the side frame member 602 includes the bottom projections 614 extending from the bottom 616 of the profile 610, and at least one of the projections 614 includes a laterally extending foot 618 that provides a surface or location where the toggle shim 700 can engage and secure the profile 610 against separating from the substrate 604.

In the illustrated embodiment, the securing device 716 of the toggle shim 700 extends into and is received within a longitudinal channel or “groove” 718 defined between laterally adjacent bottom projections 614, and at least one of the bottom projections 614 provides a foot 618 that extends laterally into the longitudinal groove 718. The toggle shim 700 is movable between a disengaged position, where the securing device 716 is disengaged from the foot 618, and an engaged position, where the securing device 716 engages the foot 618 to prevent the profile 610 from separating from the substrate 604.

The toggle shim 700 is shown in FIGS. 7A-7B in the engaged position, and is moved from the disengaged position to the engaged position by advancing the movable member 710 in a plane parallel to the surface of the substrate 604 and relative to the fixed member 708 in the direction H. As illustrated, the profile 610 may be mounted to the substrate 604 such that a clearance 720 is defined between the profile 610 and the substrate 604. To transition the toggle shim 700 from the disengaged position to the engaged position, a user (installer) may insert a screwdriver or another thin and long instrument into the clearance 720 to engage and place a lateral load on the movable member 710 in the direction H.

In FIG. 7B, the vertical styles 604 shown pivoting away from the side frame member 602 at the hinge 608. Because the toggle shim 700 is in the engaged position, the profile 610 is maintained against the substrate 604.

In some embodiments, once the toggle shim 700 is moved to the engaged position, a gasket 722 may be installed within the clearance 720. If the gasket 722 is able to be properly installed within the clearance 720, this may be an indication that the toggle shim 700 is properly placed in the engaged position. In contrast, if the gasket 722 is unable to be properly installed in the clearance 720, that may indicate that the toggle shim 700 remains in the disengaged position and the side frame member 602 is not properly secured to the substrate 604.

The toggle shim 700 may be made of any of the materials mentioned above for the toggle shim 300 of FIGS. 3A-3F. Moreover, the toggle shim 700 may serve a dual purpose as a thermal break if made of a thermally low-conductive material.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right and the like are used in relation to the illustrative embodiments as they are depicted in the figures, the upward direction being toward the top of the corresponding figure and the downward direction being toward the bottom of the corresponding figure.

What is claimed is:

1. A fenestration system, comprising:
a frame member positionable within an opening defined in a building and adjacent a substrate of the building, the frame member including a plurality of bottom projections extending from the frame member and a foot extending laterally from at least one of the plurality of bottom projections; and
a toggle shim arranged within a clearance defined between the frame member and the substrate, the toggle shim being securable to the substrate and including a securing device providing one or more engagement members engageable with the frame member,
wherein the toggle shim is transitionable between a disengaged position, where the one or more engagement members are disengaged from the foot, and an engaged position, where the one or more engagement members are engaged with the foot and thereby prevent the frame member from separating from the substrate.

2. The fenestration system of claim 1, wherein the substrate comprises a horizontal surface and the frame member comprises a bottom frame member resting on the horizontal surface.

3. The fenestration system of claim 1, wherein the substrate comprises a vertical surface and the frame member comprises a side frame member arranged vertically against the horizontal surface.

4. The fenestration system of claim 1, wherein the toggle shim comprises an elongate body having opposing first and second ends and opposing bottom and top surfaces extending between the first and second ends, the bottom surface resting against a top surface of the substrate, and
wherein a mechanical fastener extends through the first end and into the substrate to pivotably secure the toggle shim to the substrate.

5. The fenestration system of claim 4, wherein the toggle shim is transitioned from the disengaged position to the engaged position by rotating the toggle shim about an axis extending through the mechanical fastener and in a plane parallel to an upper surface of the substrate.

6. The fenestration system of claim 4, wherein the toggle shim includes a head provided at the first end and through which the mechanical fastener extends, the head including:
a base; and
a stem extending vertically from the base,
wherein the securing device is provided on an end of the stem and the one or more engagement members extend laterally outward from the stem such that a gap is defined between the base and the one or more engagement members to receive the foot when the toggle shim transitions to the engaged position.

7. The fenestration system of claim 6, wherein the securing device is extendable into a longitudinal groove defined between laterally adjacent bottom projections of the plurality of bottom projections, and each laterally adjacent bottom projection provides a foot extending laterally into the longitudinal groove, and
wherein the one or more engagement members comprise two engagement members arranged on opposite sides of the securing device and each engagement member is engageable with a corresponding foot of the laterally adjacent bottom projections when the toggle shim transitions to the engaged position.

8. The fenestration system of claim 4, wherein the second end of the body extends out of the clearance when the toggle shim is in the disengaged position.

9. The fenestration system of claim 1, wherein the toggle shim comprises:
a fixed member securable to the substrate and defining a slot; and
a movable member that includes an elongate body having opposing first and second ends and opposing bottom and top surfaces extending between the first and second ends, the first end extending into the slot and the bottom surface resting against a top surface of the substrate,
wherein the securing device is provided at the second end and the movable member is movable to transition the toggle shim between the disengaged and engaged positions.

10. The fenestration system of claim 9, wherein the toggle shim further includes a mating mechanism comprising:
one or more first protrusions provided by the fixed member and extending into the slot; and
one or more second protrusions provided by the movable member and extending into the slot,
wherein interaction between the one or more first and second protrusions maintains the toggle shim in the disengaged position until a lateral load is applied to the movable member such that the one or more second protrusions bypass the one or more first protrusions as the toggle shim moves to the engaged position.

11. The fenestration system of claim 9, wherein the securing device is extendable into a longitudinal groove defined between laterally adjacent bottom projections of the plurality of bottom projections, and
wherein the one or more engagement members comprises a single engagement member engageable with the foot when the toggle shim transitions to the engaged position.

12. The fenestration system of claim 1, wherein the toggle shim comprises:
a first fixed member that defines a recessed slot;
a second fixed member received within the recessed slot and defining a recessed slide channel, wherein securing the second fixed member to the substrate simultaneously secures the first fixed member to the substrate; and
a movable member received within the recessed slide channel and movable relative to the first and second fixed members, the movable member providing the securing device such that moving the movable member transitions the toggle shim between the disengaged and engaged positions.

13. The fenestration system of claim 12, wherein the first fixed member provides a substrate transition lip extendable over an end of the substrate to help properly orient a position the toggle shim relative to the substrate.

14. The fenestration system of claim 12, wherein the toggle shim further includes a mating mechanism comprising:
one or more arms provided by the movable member;
a protrusion provided on an end of each arm; and
a plurality of pockets defined in the recessed slide channel and sized to receive and mate with the protrusion,
wherein interaction between the protrusion and the plurality of pockets maintains the toggle shim in the disengaged position until a lateral load is applied to the movable member such that the protrusion moves from a first pocket of the plurality of pockets to a second pocket of the plurality of pockets as the toggle shim moves to the engaged position.

15. The fenestration system of claim 12, wherein the securing device is extendable into a longitudinal groove defined between laterally adjacent bottom projections of the plurality of bottom projections, and
wherein the one or more engagement members comprises a single engagement member engageable with the foot when the toggle shim transitions to the engaged position.

16. A method of securing a frame member of a fenestration system, the method comprising:
securing a toggle shim to a substrate provided in an opening defined in a building, the toggle shim including a securing device providing one or more engagement members;
positioning the frame member adjacent the substrate such that the toggle shim is arranged within a clearance defined between the frame member and the substrate, the frame member including a plurality of bottom projections extending from the frame member and a foot extending laterally from at least one of the plurality of bottom projections;
transitioning the toggle shim from a disengaged position, where the one or more engagement members are disengaged from the foot, to an engaged position, where the one or more engagement members are engaged with the foot; and
preventing the frame member from separating from the substrate with the toggle shim in the engaged position.

17. The method of claim 16, wherein the toggle shim comprises an elongate body having opposing first and second ends and a mechanical fastener extends through the first end and into the substrate to pivotably secure the toggle shim to the substrate, and wherein transitioning the toggle shim from the disengaged position to the engaged position comprises rotating the toggle shim about an axis extending through the mechanical fastener and in a plane parallel to an upper surface of the substrate.

18. The method of claim 17, wherein the one or more engagement members comprise two engagement members arranged on opposite sides of the securing device, and wherein positioning the frame member adjacent the substrate comprises:
receiving the securing device within a longitudinal groove defined between laterally adjacent bottom projections of the plurality of bottom projections, each laterally adjacent bottom projection providing a foot extending laterally into the longitudinal groove; and
rotating the toggle shim until each engagement member engages with a corresponding foot of the laterally adjacent bottom projections.

19. The method of claim 16, wherein the toggle shim comprises a fixed member securable to the substrate and defining a slot, and a movable member extendable within the slot and having the securing device mounted thereto, and wherein transitioning the toggle shim from the disengaged position to the engaged position comprises:
moving the movable member relative to the fixed member until the one or more engagement members receive and are engaged with the foot.

20. The method of claim 16, wherein the toggle shim comprises a first fixed member that defines a recessed slot, a second fixed member received within the recessed slot and defining a recessed slide channel, and a movable member received within the recessed slide channel and movable relative to the first and second fixed members, the movable member providing the securing device, and wherein transitioning the toggle shim from the disengaged position to the engaged position comprises:
moving the movable member relative to the first and second fixed members until the one or more engagement members receive and are engaged with the foot.
